(19) United States
(12) Patent Application Publication
(10) Pub. No.: US 2015/0344318 A1
(43) Pub. Date: Dec. 3, 2015

(54) RECYLING METHOD OF PURE AMMONIUM SULFATE AQUEOUS SOLUTION

(71) Applicant: KOREA INSTITUTE OF GEOSCIENCE AND MINERAL RESOURCES, Daejeon (KR)

(72) Inventors: MYUNG GYU LEE, Daejeon (KR); YOUNG NAM JANG, Daejeon (KR); HWAN JU JO, Daejeon (KR); SOO CHUN CHAE, Seoul (KR); HYE-IN WON, Cheongju-si (KR)

(21) Appl. No.: 14/717,574

(22) Filed: May 20, 2015

(30) Foreign Application Priority Data
May 22, 2014 (KR) 10-2014-0061435

(51) Int. Cl. C01C 1/24

(52) U.S. Cl. CPC C01C 1/24

(57) ABSTRACT

Provided is a method of recycling a high purity ammonium sulfate aqueous solution including: adding slurry obtained by mixing water, aqueous ammonia, and gypsum with each other and a predetermined amount of carbon dioxide to a reactor to performing a carbonation reaction, wherein an ammonium sulfate aqueous solution produced in the reactor is circulated in the reactor.

### CROSS-REFERENCE TO RELATED APPLICATIONS

This application claims priority under 35 U.S.C. §119 to Korean Patent Application No. 10-2014-0061435, filed on May 22, 2014, in the Korean Intellectual Property Office, the disclosure of which is incorporated herein by reference in its entirety.

### TECHNICAL FIELD

The following disclosure relates to a method of recycling a high purity ammonium sulfate aqueous solution, and more particularly, to a method capable of circulating and recycling an ammonium sulfate aqueous solution generated at the time of preparing high purity ammonium sulfate and calcium carbonate from gypsum, particularly, waste gypsum (gypsum dihydrate, CaSO₄.2H₂O).

### BACKGROUND

Waste gypsum, which is in a form of gypsum dihydrate, is generally referred to as chemical gypsum. Currently, industrial companies that use sulfuric acid or generate sulfuric acid as waste discharge about 400,000 ton of waste gypsum in one year in Korea. Whether or not gypsum is recycled depends on a purity of gypsum, and currently, gypsum having a purity of 94% or more may be used in a gypsum board, plaster, and the like, but an amount of currently produced chemical gypsum exceeds the demand in a gypsum industry. Although commercial available by-products account for about 80 to 90% of flue gas desulfurization gypsum produced by a coal-fired thermal power plant, the number of coal-fired thermal power plants has been continuously increased, and most of the chemical gypsum generated from fertilizer companies is in an open-air storage facility. Therefore, a recycling rate is inevitably decreased, thereby causing environmental contamination. One of the methods capable of solving this problem is to recover ammonium sulfate and calcium carbonate from waste gypsum to recycle them as resources.

As a method of preparing ammonium sulfate using gypsum and ammonia, there is a method referred to as a Mersberg process, and this method has been initially suggested early in the nineteenth century. This process has been tentatively used in England and India in the 1960s. Meanwhile, a process of recycling ammonium sulfate during a process for preparing an ammonium phosphate ((NH₄)₃PO₄) fertilizer was tested early in the 1960s in U.S. A typical reaction condition was to maintain a reaction at 70° C. for 5 hours, and it was reported that a conversion rate reached 95%. Recently, a technology of reacting ammonium carbonate ((NH₄)₂CO₃) with gypsum to prepare ammonium sulfate and calcium carbonate has been studied by the United States Geological Survey (Chou et al., 2005). However, in this study, ammonia was excessively injected, and a reaction cost was higher than a current international cost of ammonium sulfate by using an endothermic reaction, such that it may be difficult to secure economic feasibility. In addition, an initial reaction temperature was 50 to 60° C., and a recovery rate was low (83%). Therefore, in order to secure economic feasibility by a general chemical reaction as in the above-mentioned condition by the Mersberg process, the international cost of ammonium sulfate would have rapidly increased by about 30% or more. However, currently, since all ammonium sulfate internationally sold is produced using by-products in chemical companies, in fact, a possibility that the cost of ammonium sulfate will rapidly increase is low.

Research into a technology of preparing calcium carbonate as a main product and ammonium sulfate as a by-product by using gypsum in a mineral carbonation reaction has been conducted by the Korea Institute of Geoscience and Mineral Resources in 2008 (Korean Patent Laid-Open Publication No. 10-2010-0008342, Publication Date: Jan. 25, 2010, Title: “Sequestration of Carbon Dioxide by the Waste Gypsum” (Patent Document 1).

In addition, (a) a method of separating animal feces into a solid component and a liquid component on a large scale, (b) collecting CO2 gas and ammonia gas, (c) reacting the separated liquid component and the collected CO2 gas and ammonia gas, and the like, disclosed in Korean Patent No. 10-0723066 (Title: “Fertilizing Process for Livestock Excretion and System Thereof”, (Patent Document 2)) were not practical nor specific, and contents of used ammonia and CO₂ were not stated at all in this patent, such that it was impossible to recognize a ratio of prepared calcium carbonate and ammonium sulfate, and efficiency was also significantly low. Therefore, in fact, a possibility that the prepared ammonium sulfate could be used as a resource or economic feasibility could be secured is low.

Further, although a method of preparing ammonium sulfate using ammonium carbonate and gypsum as raw materials has been stated by Yun Kyung Shin (“Preparation of Ammonium Sulfate from By-Product Gypsum”, Seoul National University, 1983) in a report known before this application, in this reaction, which is a two-step reaction of (a) preparing ammonium carbonate and (b) reacting the prepared ammonium carbonate with gypsum later, a process was complicated, and the reaction between ammonium carbonate and gypsum is an endothermic reaction and requires heat (see the following Reaction Formula 1).

In addition, production efficiency of ammonium sulfate and calcium carbonate was not stated in this method, and a stoichiometric composition was used, such that this method is somewhat far from resource recovery.

2NH₃+H₂O+CO₂→(NH₄)₂CO₃

(NH₄)₂CO₃+CaSO₄.2H₂O→CaCO₃+(NH₄)₂SO₄+12 KJ(Endothermic reaction) [Reaction Formula 1]

Further, in the case of mixing and reacting gypsum, ammonia, and CO₂ with each other at a stoichiometric ratio, at the time of considering costs of raw materials, a reaction cost, and reaction efficiency, it is impossible to secure economic feasibility, such that this process cannot but be confined only to academic theory. For example, assuming that 100,000 ton/year of gypsum was treated, loss is expected to be at least about 20 billion Won, and at most 50 billion Won in calculation.

As described above, the method of preparing ammonium sulfate using gypsum has been suggested and attempted a long time ago. However, in the case in which a predetermined ratio of a starting material is not injected in order to produce ammonium sulfate fertilizer using gypsum, purities of calcium carbonate and ammonium sulfate, which are products after the reaction, are decreased, and reaction efficiency and a recovery rate are decreased, such that a production cost is increased. Further, at the time of preparation, a large amount of heat energy is used in the endothermic reaction or evaporation of water, and as a result, manufacturing cost is increased. Therefore, there is a necessity for a method capable of preparing ammonium sulfate using waste gypsum while decreasing consumption of heat energy.

### RELATED ART DOCUMENT

### Patent Document

Korean Patent Laid-Open Publication No. 10-2010-0008342 (Jan. 25, 2010)

Korean Patent No. 10-0723066 (May 22, 2007)

### SUMMARY

An embodiment of the present invention is directed to providing a method of recycling an ammonium sulfate aqueous solution capable of significantly decreasing heat energy cost used at the time of preparing ammonium sulfate by performing a carbonation reaction on waste gypsum and circulating a subsequently produced ammonium sulfate aqueous solution.

Another embodiment of the present invention is directed to providing a method of recycling an ammonium sulfate aqueous solution capable of decreasing cost and generation of greenhouse gas by using flue gas generated in a steam supply and power plant or thermal power plant in order to cheaply and easily supply carbon dioxide required at the time of preparing ammonium sulfate.

The present invention relates to a method of recycling a high purity ammonium sulfate aqueous solution.

In one general aspect, a method of recycling a high purity ammonium sulfate aqueous solution includes: adding slurry obtained by mixing water, aqueous ammonia, and gypsum with each other and a predetermined amount of carbon dioxide to a reactor to perform a carbonation reaction, wherein an ammonium sulfate aqueous solution produced in the reactor is circulated in the reactor.

The ammonium sulfate aqueous solution may have a concentration lower than a supersaturation concentration, and more particularly, satisfy the following Equation 1.

y=41.167e^{0.0021e} [Equation 1]

(In Equation 1, e is a natural constant, x is a temperature of the ammonium sulfate aqueous solution, and y is a concentration of the ammonium sulfate aqueous solution.)

In the case of circulating the ammonium sulfate aqueous solution, the ammonium sulfate aqueous solution may be added so as to replace 0.01 to 99.9 vol % of water based on 100 vol % of water.

In addition, in the slurry, 180 to 350 parts by weight of water and 100 to 150 parts by weight of aqueous ammonia may be mixed with each other based on 100 parts by weight of gypsum, and carbon dioxide may be supplied at a flow rate of 8 to 20 cc/min per 1 g of gypsum.

An initial reaction temperature of the slurry may be 5 to 18° C., and a concentration of the slurry may be 10 to 40 wt %.

In the method of recycling a high purity ammonium sulfate aqueous solution, the carbonation reaction is performed at room temperature and pressure.

### BRIEF DESCRIPTION OF THE DRAWINGS

FIG. 1 is a flow chart for explaining a method of recycling a high purity ammonium sulfate aqueous solution according to the present invention.

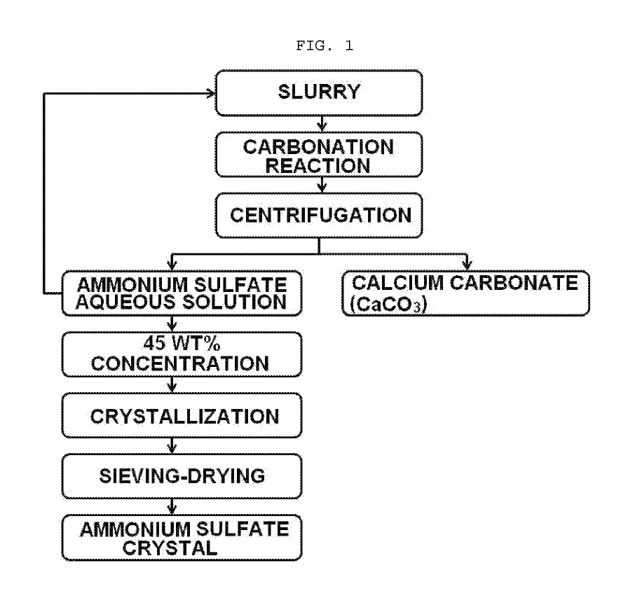

### DETAILED DESCRIPTION OF EMBODIMENTS

Hereinafter, a method of recycling a high purity ammonium sulfate aqueous solution according to the present invention will be described in more detail through the following detailed examples or exemplary embodiments. However, the following detailed examples or exemplary embodiments are only to specifically explain the present invention. Therefore, the present invention is not limited thereto, but may be implemented in various forms.

In addition, unless defined otherwise in the specification, all the technical and scientific terms used in the specification have the same meanings as those that are generally understood by those who skilled in the art. The terms used in the specification are only to effectively describe a specific exemplary embodiment, but are not to limit the present invention.

Further, the accompanying drawings to be described below are provided by way of example so that the idea of the present invention can be sufficiently transferred to those skilled in the art to which the present invention pertains. Therefore, the present invention is not limited to the drawings to be provided below, but may be modified in many different forms. In addition, the drawings to be provided below may be exaggerated in order to clarify the scope of the present invention. Like reference numerals denote like elements throughout the specification.

In addition, unless the context clearly indicates otherwise, it should be understood that a term in singular form used in the specification and the appended claims includes the term in plural form.

First, unless described otherwise, the term ‘high purity’ used in the present specification should be interpreted as a purity of 90% or more, more preferably, 95% or more.

Mineral Carbonation suggested in the present invention, which is an exothermic reaction, has advantages in that heating is not required, and even in the case of performing a reaction without a mineral dressing process of a starting material, generated calcium carbonate (CaCo₃) and ammonium sulfate have a high purity of at least 95% or more and may be recycled (see the following Reaction Formula 2). Theoretically, 4 million ton/year of gypsum generated in Korea may treat about 1 million ton/year of separated and recovered carbon dioxide, and as a result, in addition to resource recovery of 2.4 million ton/year of calcium carbonate and 2.8 million ton/year ammonium sulfate, other ripple effects are significant.

2NH₄(OH)+H₂O+CaSO₄+CO₂→CaCO₃+(NH₄)₂SO₄−98 KJ(exothermic reaction) (Reaction Formula 2)

Impurities such as phosphate ore, and the like, are contained in phospho-gypsum discarded as waste, but a gypsum component and other impurities may be separated and purified by a gravity separation method, or the like, such that gypsum having a purity of about 99% may be obtained after purification.

Meanwhile, since flue gas desulfurization gypsum has a purity of about 96 to 98%, in the present invention, a separate mineral dressing process will be omitted in order to decrease cost. In the case of omitting the mineral dressing process, when carbonation reaction efficiency reaches 100%, calcium carbonate having a purity of 95 to 96% or more may be recovered. Therefore, a recovery rate of ammonium sulfate may be expected to be at most 100%.

The method of recycling a high purity ammonium sulfate aqueous solution according to the present invention may include: adding slurry obtained by mixing water, aqueous ammonia, and gypsum with each other and a predetermined amount of carbon dioxide to a reactor to perform a carbonation reaction. However, before preparing of the slurry, a) drying gypsum powder at 60° C. or less to remove surface water in a state in which a separate mineral dressing process is omitted; and b) powdering the dried gypsum powder so as to have a fineness of 100 meshes or less may be performed.

In step a), surface water of the gypsum is simply dried at about 60° C. for 12 to 24 hours. At this time, the gypsum is in a gypsum dihydrate (CaSO₄.2H₂O) state in which two water molecules are contained, but in the case of heating the gypsum for a long period of time, while crystal water is separated, the gypsum may be converted into gypsum hemihydrate (CaSO₄.0.5H₂O). However, the converted gypsum hemihydrate may deteriorate carbonation reaction efficiency.

Next, in step b), the dried gypsum dihydrate is ground, and only a sample having a fineness of 100 meshes or less is separated using a suitable sieve to thereby be used.

Then, the slurry may be prepared by stirring the prepared gypsum dihydrate powder, water, and aqueous ammonia. It is preferable that purified water is used as the water, and a concentration of the aqueous ammonia is not limited, but may be preferably 10 to 40%.

In addition, the slurry may contain 90 to 150 parts by weight of aqueous ammonia and 100 to 400 parts by weight of water based on 100 parts by weight of gypsum dihydrate powder. In the case in which the content of the added aqueous ammonia is less than 90 parts by weight or more than 150 parts by weight, recovery rates of calcium carbonate and ammonium sulfate generated after the carbonation reaction may be significantly decreased. Further, a concentration of the prepared slurry may be 15 to 30 wt %. When the concentration of the slurry is excessively low, additional cost may be consumed during a concentration, evaporation, and drying process of ammonium sulfate, and when the concentration of the slurry is excessively low, reaction efficiency may be decreased. Therefore, it is preferable that the concentration of the slurry is in the above-mentioned range.

The next step is preparing calcium carbonate (CaCO₃) and ammonium sulfate ((NH₄)₂SO₄) by injecting carbon dioxide into the mixed slurry to perform the carbonation reaction and this step may be performed according to the following Reaction Formula 3.

2NH₄(OH)+xH₂O+CaSO₄.2H₂O+CO₂→CaCO₃+(NH₄)₂SO₄+yH₂O (Reaction Formula 3)

The carbonation reaction may be performed by stirring the slurry at the initial reaction temperature of 5 to 18° C., that is, at room temperature and pressure without a separate heating process, and when the reaction was terminated, the temperature is increased to 20 to 30° C. by the exothermic reaction, such that the carbonation reaction may be effectively carried out within the above-mentioned temperature range. In the case in which the reaction temperature is 0° C. or less, the recovery rate may be decreased.

Meanwhile, a supply amount of CO₂ may be indicated by a ratio of gypsum and CO₂, and when the reaction starts at room temperature and pressure conditions, it is preferable to supply CO₂ gas in a range of 8 cc or more, preferably, 8 to 20 cc, more preferably 10 to 15 cc per 1 g of gypsum. When the supply amount of CO₂ is more than the above-mentioned range, expensively collected CO₂ is wasted, and when the supply amount is less than the above-mentioned range, production efficiency of calcium carbonate and ammonium sulfate is rapidly decreased, and the purity of calcium carbonate becomes 95% or less, such that the recovery rate of ammonium sulfate is rapidly decreased, which is not preferable. Alternatively, in the case of calculating the amount based on part by weight, it is preferable that 20 to 80 parts by weight of CO₂ is contained based on 100 parts by weight of gypsum dihydrate.

However, since at the time of performing the carbonation reaction in the present invention, flue gas may be used, other components constituting the flue gas in addition to CO₂, for example, nitrogen and a small amount of nitrogen oxide, carbon monoxide, sulfur compounds, or the like, may be further contained.

The slurry subjected to the carbonation reaction may be divided into calcium carbonate and ammonium sulfate. When the carbonation reaction is terminated, calcium carbonate and ammonium sulfate are produced in a slurry state, and since calcium carbonate is in a solid state and ammonium sulfate is in an aqueous solution state, calcium carbonate and the ammonium sulfate aqueous solution may be separated by a centrifuge, a press filter, or the like.

In the present invention, it is preferable that a concentration of the ammonium sulfate aqueous solution is lower than a supersaturation concentration. Here, the term “supersaturation” means a state in which an amount of dissolved solute is larger than a solubility of a solution having a certain temperature, and in the present invention, when the concentration of the ammonium sulfate aqueous solution is higher than the supersaturation concentration at the time of separating the solid calcium carbonate and ammonium sulfate aqueous solution through the carbonation reaction, ammonium sulfate is precipitated, and it is impossible to separate calcium carbonate and ammonium sulfate. Therefore, it is significantly important to adjust the concentration of the aqueous solution.

In the present invention, it is more preferable that the ammonium sulfate aqueous solution satisfies the following Equation.

y=41.167e^{0.0021x} [Equation 1]

(In Equation 1, e is a natural constant, x is a temperature of the ammonium sulfate aqueous solution, and y is a concentration of the ammonium sulfate aqueous solution.)

Equation 1 indicates a supersaturation concentration of the ammonium sulfate aqueous solution depending on a temperature, and the ammonium sulfate aqueous solution capable of being used in the present invention may be determined through Equation 1. For example, in the case in which the temperature of the ammonium sulfate aqueous solution is 20° C., the supersaturation concentration is 42 wt %, but the temperature is increased to 60° C., the supersaturation concentration is also increased to 47 wt %. Therefore, it is preferable to adjust the aqueous solution at a temperature or concentration at which ammonium sulfate is not precipitated by substituting the temperature or concentration in Equation.

In the present invention, the ammonium sulfate aqueous solution may be transferred to the reactor in the preparing of the slurry to thereby be circulated in order to replace a predetermined amount of water used at the time of carbonating gypsum. Therefore, the concentration of the prepared ammonium sulfate aqueous solution may be further increased, and heat energy consumed during a preparing process of an ammonium sulfate crystal may be significantly decreased.

An amount of the ammonium sulfate aqueous solution transferred during the circulation process may replace 0.01 to 99.9 vol % of water based on 100 vol % of water used at the time of preparing the entire slurry. In addition, the number of circulation of the ammonium sulfate aqueous solution is not limited, and the concentration of ammonium sulfate is increased through circulation, such that the circulation process may be continuously repeated until the ammonium sulfate aqueous solution in the above-mentioned range is prepared.

The prepared ammonium sulfate aqueous solution may be finally concentrated to a predetermined concentration in order to be injected into a crystallizer. The concentration is to further increase the concentration of the ammonium sulfate aqueous solution to promote crystallization and it is preferable that an evaporation process is performed so that the ammonium sulfate aqueous solution is concentrated so as to have a concentration of approximately 45 wt %, but the present invention is not limited thereto.

An ammonium sulfate crystal is produced by performing a crystallization process on the ammonium sulfate aqueous solution concentrated to 45 wt % through the evaporation. A size of the ammonium sulfate crystal produced from the ammonium sulfate aqueous solution by crystallization may be 1 to 3 mm. In addition, a final ammonium sulfate product may be obtained by sieving and drying the ammonium sulfate crystal of which crystallization is terminated.

The dried calcium carbonate powder and ammonium sulfate crystal may be confirmed through instrumental analysis such as X-ray diffraction analysis, or the like. Since calcium carbonate may have a purity of about 95 to 97% and ammonium sulfate has a purity of about 95% through thermal analysis, it may be appreciated that efficiency is significantly high.

Hereinafter, the method of recycling an ammonium sulfate aqueous solution according to the present invention will be described in more detail through Examples and Comparative Examples. However, the following Examples and Comparative Examples are only to specifically explain the present invention, but the present invention is not limited thereto.

### EXAMPLE 1

### Recycling of Ammonium Sulfate Aqueous Solution (Solid-Liquid Ratio: 0.148 (Kg/L))

Slurry was prepared by mixing an ammonium sulfate aqueous solution, water, aqueous ammonia (29%), and gypsum dihydrate simply dried without a mineral dressing process. The prepared slurry was put into a carbonation reactor and carbon dioxide and nitrogen were injected, thereby performing a carbonation reaction.

After the reaction was terminated, centrifugation was performed at 1000 rpm for 10 minutes using a centrifuge (Union32R, Hanil), solid calcium carbonate and an ammonium sulfate aqueous solution were separated from each other.

A concentration of the prepared ammonium sulfate aqueous solution was 37.37 wt %. 698.11 g of 37.37 wt % ammonium sulfate aqueous solution was circulated to the reactor again in the preparing of the slurry so that the next carbonation reaction was performed, and the remaining ammonium sulfate aqueous solution was concentrated to 45 wt % for crystallization.

The ammonium sulfate aqueous solution concentrated to 45 wt % was crystallized, thereby obtaining a crystal having an average particle size of 2 mm. The obtained crystal was sieved and dried, thereby finally obtaining a white ammonium sulfate crystal. The compositions before and after injection in the carbonation reactor, the centrifuge, and the concentrator in the Example were illustrated in the following Table 1, and experimental conditions and results were illustrated in the following Tables 6 and 7, respectively.

TABLE 1

| | | |
|---|---|---|
| <Carbonation Reactor> | | |
| 1. Input | | |
| Gypsum | 100.00 | Kg/hr |
| Aqueous Ammonia (29%) | 81.87 | Kg/hr (use amount) |
| Amount of Required Solution | 584.83 | Kg/hr |
| Ammonium Sulfate Aqueous Solution | 698.11 | Kg/hr |
| Ammonium Sulfate | 260.91 | Kg/hr |
| Water | 437.20 | Kg/hr |
| Additive | 0.14 | Kg/hr |
| CO2 | 47.18 | Kg/hr (use amount) |
| N2 | 170.19 | Kg/hr (use amount) |
| 2. Output | | |
| Calcium Carbonate | 58.14 | Kg/hr |
| Ammonium Sulfate | 337.66 | Kg/hr |
| Water (from Gypsum, Aqueous Ammonia, | 516.39 | Kg/hr |
| Water) | | |
| Unreacted CO2 Gas | 21.62 | Kg/hr |
| Unreacted N2 Gas | 170.19 | Kg/hr |
| Unreacted NH3 Gas | 3.96 | Kg/hr |
| <Centrifuge> | | |
| 1. Input | | |
| Calcium Carbonate | 58.14 | Kg/hr |
| Ammonium Sulfate | 337.66 | Kg/hr |
| Water (from Gypsum, Aqueous Ammonia, | 516.39 | Kg/hr |
| Water) | | |
| Washing Water | 58.14 | Kg/hr |
| 2. Output | | |
| Calcium Carbonate | 58.14 | Kg/hr |
| Brine in Calcium Carbonate | 8.72 | Kg/hr |
| Ammonium Sulfate | 337.66 | Kg/hr |
| Water (Existing + Washing Water − | 565.81 | Kg/hr |
| Brine) | | |
| <Concentrator> | | |
| 1. Input | | |
| Ammonium Sulfate | 76.75 | Kg/hr |
| Water (Existing + Washing Water − | 128.61 | Kg/hr |
| Brine) | | |
| 2. Output | | |
| Ammonium Sulfate | 76.75 | Kg/hr |
| Water | 93.81 | Kg/hr |
| Evaporated Water (Existing − Remaining | 34.80 | Kg/hr |
| Water) | | |

### EXAMPLE 2

### Recycling of Ammonium Sulfate Aqueous Solution (Solid-Liquid Ratio: 0.292 (Kg/L))

An ammonium sulfate crystal was prepared by the same method as in Example 1 except for maintaining a solid-liquid ratio at 0.292 (Kg/L) as described above and recycling 300.03 g of the ammonium sulfate aqueous solution prepared through the carbonation reaction. The compositions before and after injection in the carbonation reactor, the centrifuge, and the concentrator in the Example were illustrated in the following Table 2, and experimental conditions and results were illustrated in the following Tables 6 and 7, respectively.

TABLE 2

| | | |
|---|---|---|
| <Carbonation Reactor> | | |
| 1. Input | | |
| Gypsum | 100.00 | Kg/hr |
| Aqueous Ammonia (29%) | 81.86 | Kg/hr (use amount) |
| Amount of Required Solution | 251.48 | Kg/hr |
| Ammonium Sulfate Aqueous Solution | 300.03 | Kg/hr |
| Ammonium Sulfate | 112.11 | Kg/hr |
| Water | 187.92 | Kg/hr |
| Additive | 0.19 | Kg/hr |
| CO2 | 47.18 | Kg/hr (use amount) |
| N2 | 170.19 | Kg/hr (use amount) |
| 2. Output | | |
| Calcium Carbonate | 58.14 | Kg/hr |
| Ammonium Sulfate | 188.86 | Kg/hr |
| Water (from Gypsum, Aqueous Ammonia, | 267.16 | Kg/hr |
| Water) | | |
| Unreacted CO2 Gas | 21.62 | Kg/hr |
| Unreacted N2 Gas | 170.19 | Kg/hr |
| Unreacted NH3 Gas | 3.96 | Kg/hr |
| <Centrifuge> | | |
| 1. Input | | |
| Calcium Carbonate | 58.14 | Kg/hr |
| Ammonium Sulfate | 188.86 | Kg/hr |
| Water (from Gypsum, Aqueous Ammonia, | 267.16 | Kg/hr |
| Water) | | |
| Washing Water | 58.14 | Kg/hr |
| 2. Output | | |
| Calcium Carbonate | 58.14 | Kg/hr |
| Brine in Calcium Carbonate | 8.72 | Kg/hr |
| Ammonium Sulfate | 188.86 | Kg/hr |
| Water (Existing + Washing Water − | 316.58 | Kg/hr |
| Brine) | | |
| <Concentrator> | | |
| 1. Input | | |
| Ammonium Sulfate | 76.75 | Kg/hr |
| Water (Existing + Washing Water − | 128.51 | Kg/hr |
| Brine) | | |
| 2. Output | | |
| Ammonium Sulfate | 76.75 | Kg/hr |
| Water | 93.81 | Kg/hr |
| Evaporated Water (Existing − Remaining | 34.85 | Kg/hr |
| Water) | | |

### COMPARATIVE EXAMPLE 1

### Non-Recycling of Ammonium Sulfate Aqueous Solution (Solid-Liquid Ratio: 0.148 (Kg/L))

An ammonium sulfate aqueous solution was not circulated, slurry prepared by adding water, aqueous ammonia (29%), and gypsum dihydrate simply dried without a mineral dressing process was used, and a concentration of a prepared ammonium sulfate aqueous solution was 9.71 wt %. A white ammonium sulfate crystal was obtained by the same method as in Example 1 except for the above-mentioned description. The compositions before and after injection in the carbonation reactor, the centrifuge, and the concentrator in the Comparative Example were illustrated in the following Table 3, and experimental conditions and results were illustrated in the following Tables 6 and 7, respectively.

TABLE 3

| | Addi- | |
|---|---|---|
| | tion | |
| | Amount | Unit |
| <Carbonation Reactor> | | |
| 1. Input | | |
| Gypsum | 100.00 | Kg/hr |
| Aqueous Ammonia (29%) | 81.87 | Kg/hr (use amount) |
| Water | 584.83 | Kg/hr |
| CO2 | 47.18 | Kg/hr (use amount) |
| N2 | 170.19 | Kg/hr (use amount) |
| 2. Output | | |
| Calcium Carbonate | 58.14 | Kg/hr |
| Ammonium Sulfate | 76.75 | Kg/hr |
| Water (from Gypsum, Aqueous Ammonia, | 663.88 | Kg/hr |
| Water) | | |
| Unreacted CO2 Gas | 21.62 | Kg/hr |
| Unreacted N2 Gas | 170.19 | Kg/hr |
| Unreacted NH3 Gas | 3.96 | Kg/hr |
| <Centrifuge> | | |
| 1. Input | | |
| Calcium Carbonate | 58.14 | Kg/hr |
| Ammonium Sulfate | 76.75 | Kg/hr |
| Water (from Gypsum, Aqueous Ammonia, | 663.88 | Kg/hr |
| Water) | | |
| Washing Water | 58.14 | Kg/hr |
| 2. Output | | |
| Calcium Carbonate | 58.14 | Kg/hr |
| Brine in Calcium Carbonate | 8.72 | Kg/hr |
| Ammonium Sulfate | 76.75 | Kg/hr |
| Water (Existing + Washing Water − | 713.30 | Kg/hr |
| Brine) | | |
| <Concentrator> | | |
| 1. Input | | |
| Ammonium Sulfate | 76.75 | Kg/hr |
| Water (Existing + Washing Water − | 713.30 | Kg/hr |
| Brine) | | |
| 2. Output | | |
| Ammonium Sulfate | 76.75 | Kg/hr |
| Water | 93.81 | Kg/hr |
| Evaporated Water (Existing + Carbonate | 619.49 | Kg/hr |
| Decomposition − Remaining Water) | | |

### COMPARATIVE EXAMPLE 2

### Non-Recycling of Ammonium Sulfate Aqueous Solution (Solid-Liquid Ratio: 0.292 (Kg/L))

A white ammonium sulfate crystal was obtained by the same method as in Comparative Example 1 except for maintaining a solid-liquid ratio at 0.292 (Kg/L). The compositions before and after injection in the carbonation reactor, the centrifuge, and the concentrator in the Comparative Example were illustrated in the following Table 4, and experimental conditions and results were illustrated in the following Tables 6 and 7, respectively.

TABLE 4

| | Addi- | |
|---|---|---|
| | tion | |
| | Amount | Unit |
| <Carbonation Reactor> | | |
| 1. Input | | |
| Gypsum | 100.00 | Kg/hr |
| Aqueous Ammonia (29%) | 81.87 | Kg/hr (use amount) |
| Water | 251.48 | Kg/hr |
| CO2 | 47.18 | Kg/hr (use amount) |
| N2 | 170.19 | Kg/hr (use amount) |
| 2. Output | | |
| Calcium Carbonate | 58.14 | Kg/hr |
| Ammonium Sulfate | 76.75 | Kg/hr |
| Water (from Gypsum, Aqueous Ammonia, | 330.53 | Kg/hr |
| Water) | | |
| Unreacted CO2 Gas | 21.62 | Kg/hr |
| Unreacted N2 Gas | 170.19 | Kg/hr |
| Unreacted NH3 Gas | 3.96 | Kg/hr |
| <Centrifuge> | | |
| 1. Input | | |
| Calcium Carbonate | 58.14 | Kg/hr |
| Ammonium Sulfate | 76.75 | Kg/hr |
| Water (from Gypsum, Aqueous Ammonia, | 330.53 | Kg/hr |
| Water) | | |
| Washing Water | 58.14 | Kg/hr |
| 2. Output | | |
| Calcium Carbonate | 58.14 | Kg/hr |
| Brine in Calcium Carbonate | 8.72 | Kg/hr |
| Ammonium Sulfate | 76.75 | Kg/hr |
| Water (Existing + Washing Water − | 379.95 | Kg/hr |
| Brine) | | |
| <Concentrator> | | |
| 1. Input | | |
| Ammonium Sulfate | 76.75 | Kg/hr |
| Water (Existing + Washing Water − | 379.95 | Kg/hr |
| Brine) | | |
| 2. Output | | |
| Ammonium Sulfate | 76.75 | Kg/hr |
| Water | 93.81 | Kg/hr |
| Evaporated Water (Existing + Carbonate | 286.14 | Kg/hr |
| Decomposition − Remaining Water) | | |

### COMPARATIVE EXAMPLE 3

### Non-Recycling of Ammonium Sulfate Aqueous Solution (Solid-Liquid Ratio: 0.432 (Kg/L))

A white ammonium sulfate crystal was obtained by the same method as in Comparative Example 1 except for maintaining a solid-liquid ratio at 0.432 (Kg/L). The compositions before and after injection in the carbonation reactor, the centrifuge, and the concentrator in the Comparative Example were illustrated in the following Table 5, and experimental conditions and results were illustrated in the following Tables 6 and 7, respectively.

TABLE 5

| | Addi- | |
|---|---|---|
| | tion | |
| | Amount | Unit |
| <Carbonation Reactor> | | |
| 1. Input | | |
| Gypsum | 100.00 | Kg/hr |
| Aqueous Ammonia (29%) | 81.87 | Kg/hr (use amount) |
| Water | 140.36 | Kg/hr |
| CO2 | 47.18 | Kg/hr (use amount) |
| N2 | 170.19 | Kg/hr (use amount) |
| 2. Output | | |
| Calcium Carbonate | 58.14 | Kg/hr |
| Ammonium Sulfate | 76.75 | Kg/hr |
| Water (from Gypsum, Aqueous Ammonia, | 219.41 | Kg/hr |
| Water) | | |
| Unreacted CO2 Gas | 21.62 | Kg/hr |
| Unreacted N2 Gas | 170.19 | Kg/hr |
| Unreacted NH3 Gas | 3.96 | Kg/hr |
| <Centrifuge> | | |
| 1. Input | | |
| Calcium Carbonate | 58.14 | Kg/hr |
| Ammonium Sulfate | 76.75 | Kg/hr |
| Water (from Gypsum, Aqueous Ammonia, | 219.41 | Kg/hr |
| Water) | | |
| Washing Water | 58.14 | Kg/hr |
| 2. Output | | |
| Calcium carbonate | 58.14 | Kg/hr |
| Brine in Calcium Carbonate | 8.72 | Kg/hr |
| Ammonium Sulfate | 76.75 | Kg/hr |
| Water (Existing + Washing Water − | 268.82 | Kg/hr |
| Brine) | | |
| <Concentrator> | | |
| 1. Input | | |
| Ammonium Sulfate | 76.75 | Kg/hr |
| Water (Existing + Washing Water − | 268.82 | Kg/hr |
| Brine) | | |
| 2. Output | | |
| Ammonium Sulfate | 76.75 | Kg/hr |
| Water | 93.81 | Kg/hr |
| Evaporated Water (Existing + Carbonate | 175.02 | Kg/hr |
| Decomposition − Remaining Water) | | |

TABLE 6

| | | | | Amount of Recycled | Solid- |
|---|---|---|---|---|---|
| | Gyp- | Aqueous | | Ammonium Sulfate | Liquid |
| | sum | Ammonia | Water | Aqueous Solution | Ratio |
| | (g) | (g) | (g) | (g) | (Kg/L) |
| Example 1 | 100 | 81.87 | 0.14 | 698.11 | 0.148 |
| Example 2 | 100 | 81.87 | 0.19 | 300.03 | 0.292 |
| Comparative | 100 | 81.87 | 584.83 | 0 | 0.148 |
| Example 1 | | | | | |
| Comparative | 100 | 81.87 | 251.48 | 0 | 0.292 |
| Example 2 | | | | | |
| Comparative | 100 | 81.87 | 140.36 | 0 | 0.432 |
| Example 3 | | | | | |

TABLE 7

| | | | Com- | Com- | Com- |
|---|---|---|---|---|---|
| | | | para- | para- | para- |
| | | | tive | tive | tive |
| | Exam- | Exam- | Exam- | Exam- | Exam- |
| | ple 1 | ple 2 | ple 1 | ple 2 | ple 3 |
| Calcium Carbonate (g) | 58.14 | 58.14 | 58.14 | 58.14 | 58.14 |
| Ammonium Sulfate | 903.47 | 505.44 | 790.05 | 456.70 | 345.57 |
| Aqueous Solution (g) | | | | | |
| Concentration (wt %) | 37.37 | 37.37 | 9.71 | 16.81 | 22.21 |
| of Ammonium Sulfate | | | | | |
| Aqueous Solution | | | | | |
| Recycled Ammonium | 698.11 | 300.03 | 0 | 0 | 0 |
| Sulfate Aqueous | | | | | |
| Solution (g) | | | | | |
| Used Ammonium | 205.36 | 205.40 | 790.05 | 456.70 | 345.57 |
| Sulfate Aqueous | | | | | |
| Solution (g) for | | | | | |
| Concentration | | | | | |
| Water (g) to be | 34.80 | 34.85 | 619.49 | 286.14 | 175.02 |
| evaporated | | | | | |
| 45 wt % Ammonium | 170.56 | 170.56 | 170.56 | 170.56 | 170.56 |
| Sulfate Aqueous | | | | | |
| Solution (g) | | | | | |
| Produced Ammonium | 76.75 | 76.75 | 76.75 | 76.75 | 76.75 |
| Sulfate Particle (g) | | | | | |
| Carbonation | 95 | 92 | 95 | 92 | 85 |
| Reaction Rate (%) | | | | | |

In Example 1 in which used water was mostly replaced by the ammonium sulfate aqueous solution as illustrated in Table 7, 205.36 g of 37.37 wt % ammonium sulfate aqueous solution was used in the concentration process of ammonium sulfate, but in Comparative Example 1, 790.05 g of 9.71 wt % ammonium sulfate aqueous solution was used. As a result, in order to prepare 170.56 g of 45 wt % ammonium sulfate aqueous solution used for obtaining the same amount (76.75 g) of the ammonium sulfate crystal, 34.80 g of water and 619.49 g of water were evaporated in Example 1 and Comparative Example 1, respectively. Therefore, it may be appreciated that in Comparative Example 1, heat energy corresponding to about 20 times more than the amount of heat energy used in Example 1 was used for concentrating the ammonium sulfate aqueous solution.

In Example 2 in which only the solid-liquid ratio was different from Example 1, a scale of an apparatus may be decreased due to the high solid-liquid ratio, but the reaction was performed at 45 to 55° C. higher than 40 to 50° C. corresponding to a suitable temperature of the carbonation reaction. Therefore, it may be appreciated that a carbonation reaction rate was decreased as compared to Example 1.

In Comparative Example 3, the solid-liquid ratio was 0.432 (Kg/L), which was the highest solid-liquid ratio in all Examples and Comparative Examples. As a result, it may be appreciated that an amount of water to be evaporated was decreased to about ⅓ than that in Example 1, but a reaction temperature at the time of carbonation reaction was significantly increased (to 60° C. or more), such that a carbonation reaction rate was significantly decreased.

Since the method of recycling an ammonium sulfate aqueous solution according to the present invention uses waste gypsum of which a generation amount per year in Korea is several million tons as the raw material, the environment may be protected, waste resource may be recycled as the resource, and an environmental contamination problem may be basically solved. That is, high purity (95% or more) recyclable calcium carbonate and high purity (95% or more) recyclable ammonium sulfate may be prepared using waste gypsum.

In addition, greenhouse gas may be recycled and cost of supplying carbon dioxide may be significantly decreased by using exhaust gas generated in power plants, and the like, at the time of preparing ammonium sulfate.

Further, as the ammonium sulfate aqueous solution is circulated in the reactor, water used at the time of carbonating gypsum may be mostly replaced with the ammonium sulfate aqueous solution, such that the same amount of an ammonium sulfate crystal may be recovered only with 1/20 time energy cost as compared to the existing method.

1.-9. (canceled)

10. A method of preparing ammonium sulfate, the method comprising:
a) preparing slurry by mixing water, aqueous ammonia, and gypsum with each other;
b) adding carbon dioxide to the slurry to perform a carbonation reaction, thereby preparing an aqueous solution containing calcium carbonate and ammonium sulfate;
c) separating the aqueous solution containing calcium carbonate and ammonium sulfate;
d) sending the separated ammonium sulfate aqueous solution to the step b) to be circulated; and
e) obtaining a high purity ammonium sulfate aqueous solution through the circulation;
wherein the ammonium sulfate aqueous solution of the step c) has a concentration lower than a supersaturation concentration, and the supersaturation concentration satisfies the following Equation 1,
y=41.167e^{0.0021x}. [Equation 1]

11. The method of preparing ammonium sulfate of claim 10, wherein the circulated ammonium sulfate aqueous solution is added to a reactor so as to replace 0.01 to 99.9 vol % of water based on 100 vol % of water added in the carbonation reaction.

12. The method of preparing ammonium sulfate of claim 10, wherein in the slurry, 180 to 350 parts by weight of water and 100 to 150 parts by weight of aqueous ammonia are mixed with each other based on 100 parts by weight of gypsum.

13. The method of preparing ammonium sulfate of claim 10, wherein carbon dioxide is supplied at a flow rate of 8 to 20 cc/min per 1 g of gypsum.

14. The method of preparing ammonium sulfate of claim 10, wherein an initial reaction temperature of the slurry is 5 to 18° C.

15. The method of preparing ammonium sulfate of claim 10, wherein a concentration of the slurry of the step b) is 10 to 40 wt %.

16. The method of preparing ammonium sulfate of claim 10, wherein the carbonation reaction is performed at normal pressure.

| Claims in US | | |
|---|---|---|
| Application | Allowed Claims in KIPO Application | Explanation |
| 1-9 | | Canceled |
| 10 | 1 | Amended in |
| | | response to the |
| | | office action |
| | | from the KIPO |
| | 2 | Canceled in |
| | | response to the |
| | | office action |
| | | from the KIPO |
| | 3 | Canceled in |
| | | response to the |
| | | office action |
| | | from the KIPO |
| 11 | 4 | Amended in |
| | | response to the |
| | | office action |
| | | from the KIPO |
| 12 | 5 | Amended in |
| | | response to the |
| | | office action |
| | | from the KIPO |
| 13 | 6 | Amended in |
| | | response to the |
| | | office action |
| | | from the KIPO |
| 14 | 7 | Amended in |
| | | response to the |
| | | office action |
| | | from the KIPO |
| 15 | 8 | Amended in |
| | | response to the |
| | | office action |
| | | from the KIPO |
| 16 | 9 | Amended to |
| | | remove multiple |
| | | dependency |
